(19) United States
(12) Patent Application Publication
(10) Pub. No.: US 2025/0374059 A1
(43) Pub. Date: Dec. 4, 2025

(54) QUANTUM-BASED GEOSPATIAL TIME SERIES ARCHETYPAL CLUSTERING FOR RADIO RESOURCE ALLOCATION

(71) Applicant: Dell Products L.P., Round Rock, TX (US)

(72) Inventors: Vamsi Krishna Boyapati, Metairie, LA (US); Satish Venkob, Mississauga (CA)

(21) Appl. No.: 18/678,706

(22) Filed: May 30, 2024

(51) Int. Cl. H04W 16/04; H04L 1/00; H04W 48/20

(52) U.S. Cl. CPC H04W 16/04; H04L 1/0003; H04W 48/20

(57) ABSTRACT

A method facilitating quantum-based geospatial time series archetypal clustering for radio resource allocation includes generating, by a system including at least one processor and based on applying a first quantum circuit to time series data associated with radio cells of a communication network, prediction data representative of predicted data traffic rates for respective ones of the radio cells over a time interval; grouping, by the system and based on applying a second quantum circuit to the prediction data, the radio cells into clusters of the radio cells corresponding to predicted traffic patterns of the radio cells over the time interval; and allocating, by the system, a determined amount of computing resources associated with the communication network to a selected cluster of the clusters of the radio cells.

### BACKGROUND

With the advent of virtualization technologies, Virtualized RAN (V-RAN) has emerged as a revolutionary concept within the RAN architectures such as the Fifth Generation (5G) RAN architecture. In general, V-RAN can leverage cloud-native virtualization techniques to transform traditional network functions into virtualized microservices or containers. This shift from purpose-built hardware to software-based solutions allows for greater flexibility, scalability, and cost-effectiveness in network deployments. V-RAN enables the disaggregation of network components, separating conventional network functions into software-based entities that can be dynamically deployed where needed, rather than relying on fixed, hardware-based deployments. However, given the proliferation of wireless devices and the growing demand for data-intensive applications, it is becoming increasingly desirable to implement techniques to enhance the energy efficiency of RAN deployments.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include generating, using a first quantum circuit and based on time series data associated with radio cells of a communication network, prediction data including predicted data traffic rates for respective ones of the radio cells over a time interval. The operations can further include grouping, using a second quantum circuit, the radio cells into clusters of the radio cells according to predicted traffic patterns of the radio cells over the time interval as determined based on the prediction data. The operations can also include assigning a determined amount of computing resources associated with the communication network to a selected cluster of the clusters of the radio cells.

In another implementation, a method is described herein. The method can include generating, by a system including at least one processor and based on applying a first quantum circuit to time series data associated with radio cells of a communication network, prediction data representative of predicted data traffic rates for respective ones of the radio cells over a time interval. The method can also include grouping, by the system and based on applying a second quantum circuit to the prediction data, the radio cells into clusters of the radio cells corresponding to predicted traffic patterns of the radio cells over the time interval. The method can further include allocating, by the system, a determined amount of computing resources associated with the communication network to a selected cluster of the clusters of the radio cells.

In an additional implementation, a non-transitory machine-readable medium is described herein that can include instructions that, when executed by at least one processor, facilitate performance of operations. The operations can include generating, based on applying a first quantum circuit to time series data associated with radio cells of a communication network, prediction data representative of predicted data traffic rates for respective ones of the radio cells over a time interval; grouping, based on applying a second quantum circuit to the prediction data, the radio cells into clusters of the radio cells corresponding to predicted traffic patterns of the radio cells over the time interval; and allocating a determined amount of computing resources associated with the communication network to a selected cluster of the clusters of the radio cells.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates quantum-based geospatial time series archetypal clustering for radio resource allocation in accordance with various implementations described herein.

FIG. 2 is a diagram illustrating an operational framework facilitating quantum-based geospatial time series archetypal clustering for radio resource allocation in accordance with various implementations described herein.

FIGS. 3-4 are block diagrams of additional systems that facilitate quantum-based geospatial time series archetypal clustering for radio resource allocation in accordance with various implementations described herein.

FIG. 5 is a diagram illustrating another operational framework facilitating quantum-based geospatial time series archetypal clustering for radio resource allocation in accordance with various implementations described herein.

FIG. 6 is a diagram of an example architecture facilitating radio resource clustering, e.g., based on quantum-based geospatial time series archetypal clustering, in accordance with various implementations described herein.

FIGS. 7-8 are flow diagrams of respective methods that facilitate radio resource clustering, e.g., based on quantum-based geospatial time series archetypal clustering, in accordance with various implementations described herein.

FIGS. 9-10 are flow diagrams of respective methods that facilitate quantum-based geospatial time series archetypal clustering for radio resource allocation in accordance with various implementations described herein.

FIGS. 11-12 are diagrams of example computing environments in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

Advancements in wireless communication technology, such as the Fifth Generation (5G) Radio Access Network (RAN) architecture, are ushering in a new era of high-speed, low-latency connectivity. Such advancements can facilitate a diverse range of services and applications, from Internet of Things (IoT) devices to augmented reality experiences. With regard to the 5G RAN architecture in particular, said architecture comprises several key components, including Centralized Units (CUs), Distributed Units (DUs), and Radio Units (RUs), each of which play a role in delivering seamless connectivity.

Traditionally, the 5G RAN architecture involves a hierarchical structure where CUs, DUs, and RUs work together to facilitate wireless communication. CUs can be responsible for processing and managing higher-layer functions, such as user mobility and connection setup, while DUs can handle lower-layer functions such as baseband processing and radio resource management. RUs, on the other hand, can manage the transmission and reception of radio signals to and from user devices. As noted above, a Virtualized RAN (V-RAN) can also be used, which leverages cloud-native virtualization techniques to transform traditional network functions into virtualized microservices or containers.

Energy efficiency is of particular concern in modern RAN architectures, given the proliferation of wireless devices and the growing demand for data-intensive applications. For example, In the context of the 5G RAN architecture, challenges include the inability to dynamically adjust server resources to changing traffic patterns, accommodating diversity in user equipment, seamlessly integrating Machine Learning (ML) algorithms into CU and DU software, and obtaining timely predictive analytics. Existing architectures lack the flexibility to adapt to dynamic traffic fluctuations, optimize resource allocation for various devices, provide a streamlined framework for ML integration, and offer real-time predictive insights. These challenges hinder the network's ability to deliver efficient and adaptive operations in the era of 5G connectivity.

To the furtherance of the above and/or related ends, implementations described herein can optimize energy consumption by strategically managing CU and DU resources. For instance, implementations described herein can use Artificial Intelligence (AI) and/or ML algorithms to incorporate predictive analytics and geospatial-temporal data, which in turn can enable a communication system to make informed decisions regarding resource pooling and/or allocation based on anticipated network traffic demand.

Continuing the above, a RAN, such as a 5G RAN, presents a number of challenges to energy efficiency. These can include, but are not limited to, the following:

Continuous Operation: Traditional base stations can operate continuously, e.g., 24 hours a day, 7 days a week, consuming energy even during low traffic periods.

Mismatch with Traffic Patterns: Traffic patterns such as Ultra-Reliable Low Latency Communication (URLLC), Massive Machine-Type Communications (mMTC), and Enhanced Mobile Broadband (cMBB) traffic patterns differ, leading to energy waste.

Lack of Adaptability: A traditional RAN lacks adaptability to dynamically adjust resources based on traffic.

Resource Overprovisioning: Resources are often overprovisioned to ensure reliability; however, this overprovisioning leads to energy inefficiency.

In addition, a 5G RAN and/or other RAN can present challenges to dynamic computational resource allocation that can include, but are not limited to, the following:

Diverse Traffic Types: Communication networks can serve varied traffic types with distinct latency and data rate requirements.

Combinatorial Complexity: Optimally allocating resources for diverse traffic types in dynamic networks is complex.

Energy Efficiency: Traditional RANs waste energy by operating continuously, regardless of traffic load.

To address the above and/or other challenges, implementations described herein provide a solution centered around RAN energy efficiency through the utilization of a traffic-aware data and AI system. Implementations described herein can optimize network operations, adapt to dynamic traffic demands, accommodate diverse user equipment, seamlessly integrate ML algorithms into CU and DU software, and deliver real-time predictive analytics to ensure efficient and adaptive 5G RAN connectivity.

It is noted that while various examples provided herein relate to 5G deployments, these examples are provided merely for illustrative purposes and are not intended to limit the description or the claimed subject matter to any particular network standard(s) or technology(-ies) unless explicitly stated otherwise. It is also noted that, due to the nature and quantity of data that can be processed by machine learning (ML) models as described herein, as well as the manner in which such data is processed, implementations described herein can facilitate operations that could not be performed in the human mind, or by a general-purpose computer utilizing conventional computing techniques, in a useful or reasonable timeframe.

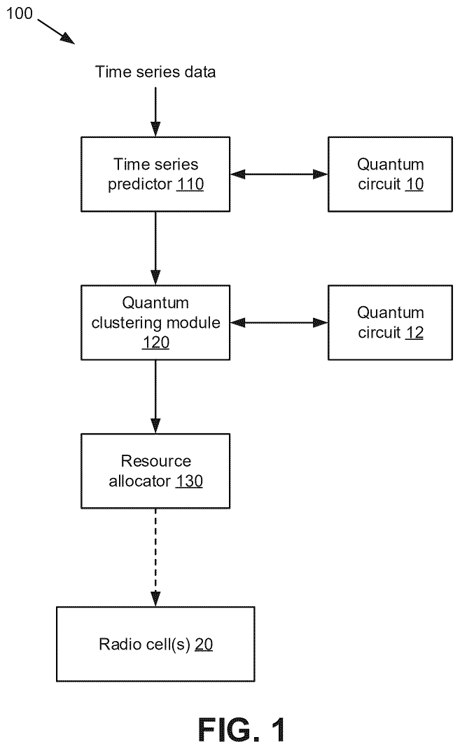

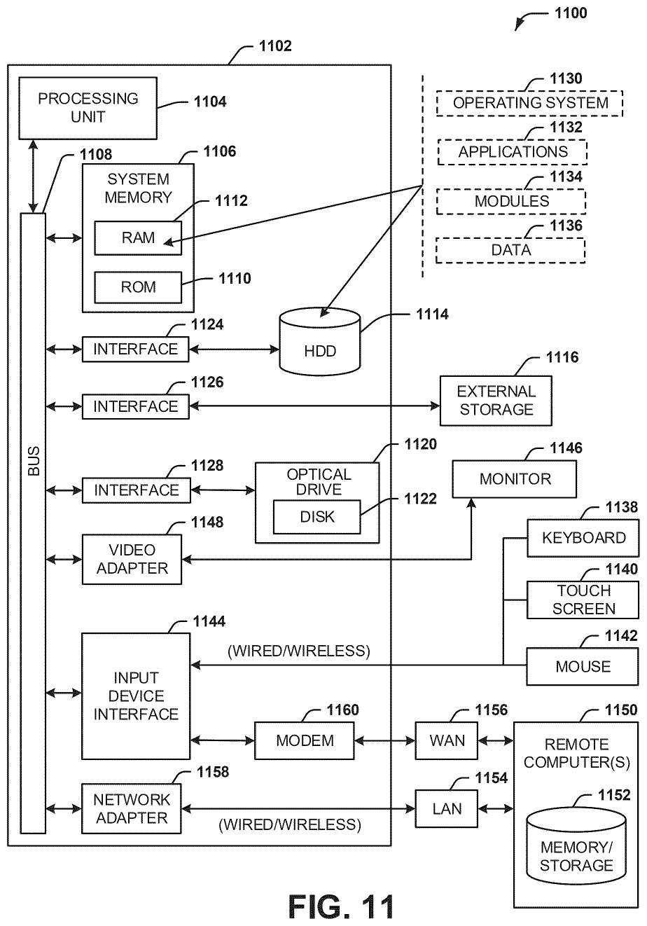

With reference now to the drawings, FIG. 1 illustrates a block diagram of a system 100 that facilitates quantum-based geospatial time series archetypal clustering for radio resource allocation in accordance with various implementations described herein. System 100 as shown in FIG. 1 includes executable components, e.g., a time series predictor 110, a quantum clustering module 120, and a resource allocator 130, each of which can operate as described in further detail below. In an implementation, the components 110, 120, 130 of system 100 can be implemented in hardware, software, or a combination of hardware and software. By way of example, the components 110, 120, 130 can be stored on at least one memory and executed by at least one processor. An example of a computer architecture including a processor and memory that can be used to implement the components 110, 120, 130, as well as other components as will be described herein, is shown and described in further detail below with respect to FIG. 11.

Additionally, it is noted that the functionality of the respective components shown and described herein can be implemented via a single computing device and/or a combination of devices. For instance, in various implementations, the time series predictor 110 shown in FIG. 1 could be implemented via a first device, the quantum clustering module 120 could be implemented via the first device or a second device, and the resource allocator 130 could be implemented via the first device, the second device, or a third device. Also, or alternatively, the functionality of a single component could be divided among multiple devices in some implementations.

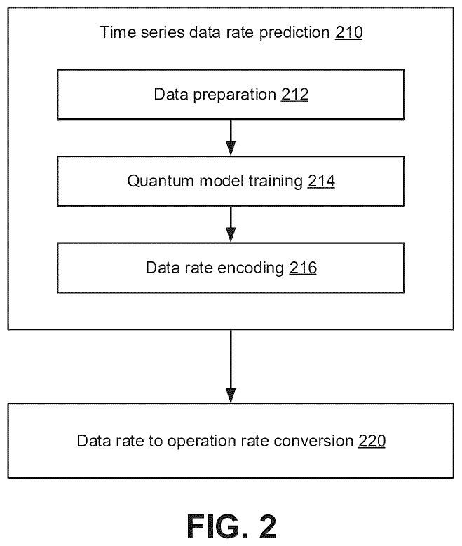

With reference now to the components of system 100, the time series predictor 110 of system 100 can generate, using a first quantum circuit 10 and based on time series data associated with radio cells 20 of a communication network, prediction data that can include predicted data traffic rates for respective ones of the radio cells 20 over a given time interval. In implementations, the prediction data can additionally include predicted data operation rates for the respective radio cells 20, e.g., by converting the predicted data traffic rates to predicted rates of computing operations for respective ones of the radio cells 20, e.g., as will be described in further detail below with respect to FIGS. 2-4.

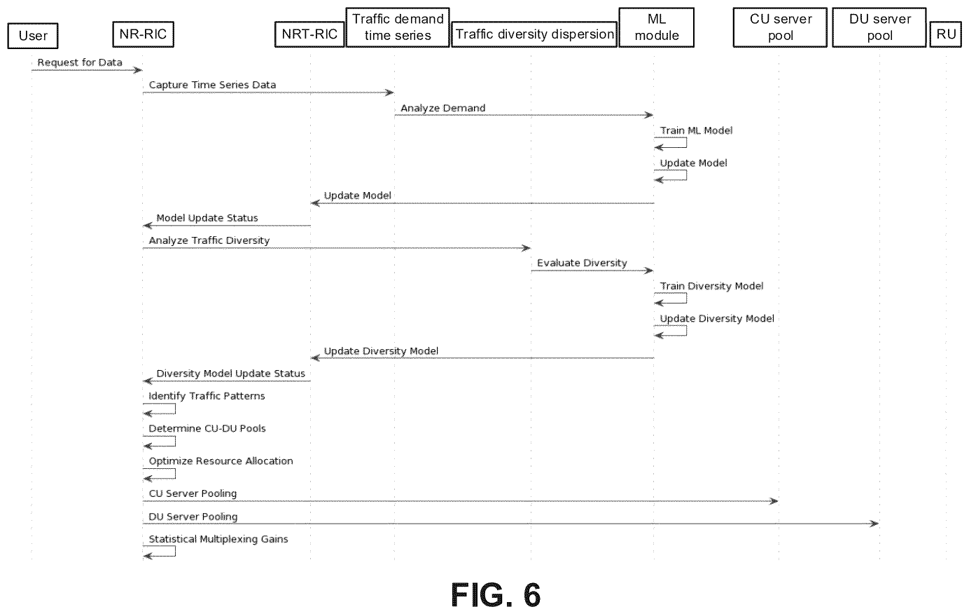

In an implementation, the time series predictor 110 can facilitate time series prediction of radio unit traffic, traffic diversity, mobility attributes, and/or other properties of radio cells 20 using data collected and pipelined into the time series predictor 110 from each radio cell 20. A data architecture that can be utilized by the time series predictor 110 for this purpose is described in further detail below with respect to FIG. 6.

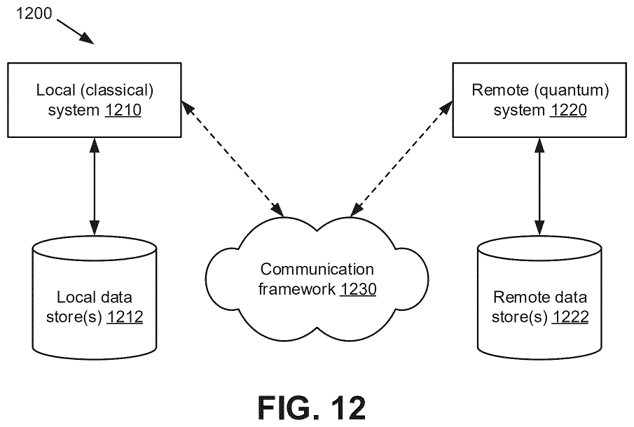

Based on the prediction data generated by the time series predictor 110 from the time series data, the quantum clustering module 120 of system 100 can, using a second quantum circuit 12, group the radio cells 20 into clusters of the radio cells 20 according to predicted traffic patterns of the radio cells over the time interval as determined based on the prediction data. In implementations, the quantum circuits 10, 12 utilized by the time series predictor 110 and the quantum clustering module 120, respectively, can be instantiated and run on a quantum computing system, which can be the same computing system as system 100 and/or a different system. For example, the components 110, 120, 130 of system 100 could operate within a classical computing system, and the classical computing system could interface with a quantum computing system on which the quantum circuits 10, 12 are run through one or more network interfaces that facilitate quantum-classical computing techniques. The quantum computing system can be, e.g., a cloud-based system that includes cloud-based quantum computing resources that are usable by system 100 to perform quantum circuit operations, such as those represented by quantum circuits 10 and 12 in FIG. 1, for generating prediction data, clustering radio cells, and/or other functionality, which can facilitate the use of scalable and flexible quantum computing power without the need for on-premises quantum infrastructure. An example of a communication framework that can be used in this manner is described in further detail below with respect to FIG. 12.

The resource allocator 130 of system 100 can assign respective groups of resources of the communication network, such as computing resources associated with servers or portions of servers (e.g., processing cores, etc.) to a selected cluster of the clusters of the radio cells 20 determined by the quantum clustering module 120. Various processes that can be used by the resource allocator 130 for assigning network resources to clustered radio cells are described below with respect to FIGS. 6-8.

By utilizing quantum circuits 10, 12 for time series prediction and radio clustering, system 100 can facilitate resource allocation decisions on a timeframe that is significantly faster than that associated with classical computing algorithms. By way of example, the quantum clustering module 120 can facilitate, using a quantum circuit 12, quantum archetypal clustering to sort respective radio cells 20 into groups based on defined archetypes, i.e., sets of common characteristics of the radio cells 20 such as service type, data rate, handover frequency, and/or other characteristics. Such clustering can be performed in a near-real-time manner, e.g., according to defined intervals of a period (15 minutes, 1 hour, etc.), providing improved ability of system 100 to adjust resource allocations in the presence of changing radio characteristics as well as reducing the amount of resources utilized for such allocations as compared to a fully classical approach.

By monitoring and clustering radio cells 20 in an ongoing (near-real-time) manner as described above, the components 110, 120, 130 of system 100 can adjust an allocation of computing resources assigned to respective radio cells 20 based on observed changes to the computing needs of the radio cells 20. By way of example, the resource allocator 130 can monitor quality of service (QOS) metrics, and/or other suitable metric data, for respective clusters of radio cells 20 formed by the quantum clustering module 120 and automatically reallocate computing resources to maintain and/or improve the observed QoS, e.g., based on predefined thresholds and/or service level agreements. To this end, the resource allocator 130 can monitor service quality metrics associated with respective clusters of the radio cells 20 as determined by the quantum clustering module 120, and then adjust a determined amount of computing resources to be assigned to one or more of those clusters based on a result of comparing the service quality metrics to a service quality threshold defined by a service level agreement. Other techniques could also be used.

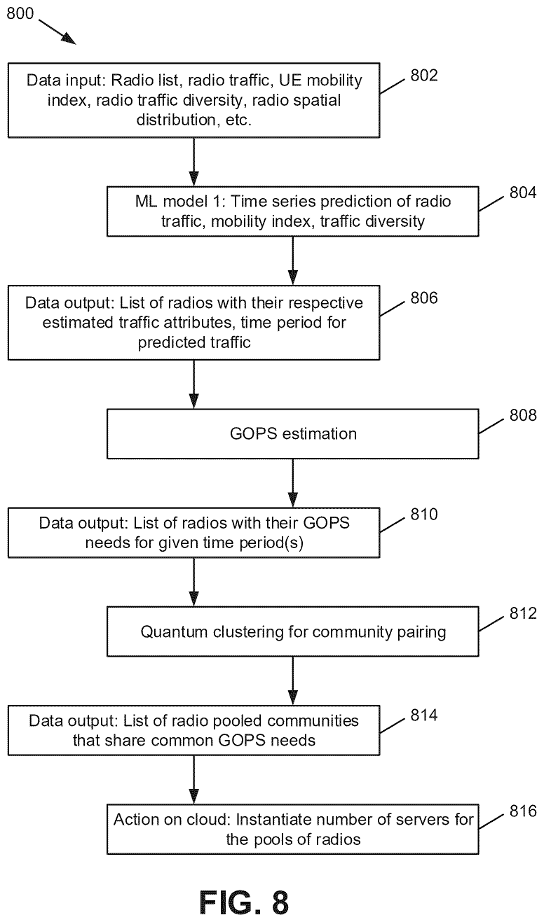

In an implementation, the above adjustments can include dynamically adjusting the number of computational cores that are allocated to each cluster of radio cells 20 based on real-time traffic fluctuations and computational demands, thereby optimizing resource utilization and maintaining an optimal level of network performance. Techniques that can be used by the resource allocator 130 to allocate resources to clusters of radio cells 20, including servers and/or computational cores associated with servers, are described in further detail below with respect to FIG. 8.

System 100 as shown in FIG. 1 can facilitate grouping of baseband units (BBUs) and/or other radio cells 20, from which a number of BBU servers, or other resources associated with handling an anticipated future load of the radio cells 20, can be predicted based on the grouping. For instance, in a cell site covering a substantial geographic area (e.g., an area spanning several hundred square kilometers), multiple radios can serve a diverse array of user equipment (UEs). The distribution of UEs across different service categories, including URLLC, mMTC, and eMBB, can vary relatively quickly over time, e.g., hourly. To optimize resource allocation and network performance, system 100 can identify and group areas with similar traffic demands. As described herein, communities with similar traffic needs can be identified via quantum archetypal clustering and/or other techniques, such as graph community pairing.

Significant challenges can arise when provisioning baseband computing resources for radios in both macro and micro scenarios, where resources are often allocated without consideration of traffic patterns. Traffic volume, being directly proportional to utilized compute resources, can play a central role in this context. The absence of traffic awareness can lead to substantial inefficiencies, including wasted computing and energy resources.

Moreover, in urban macro deployments, the spatial and temporal distribution of traffic, characterized by data volumes and the number of devices connected at specific locations and times, can exhibit high levels of sparsity. To this end, system 100 can provide a RAN with the capability to recognize low-latency interval traffic patterns in a spatio-temporal matrix dynamically. Incorporating dynamic sensing into RAN infrastructure can significantly enhance its efficiency by adjusting resource allocation based on real-time traffic data, thereby reducing unnecessary resource consumption and improving overall network performance.

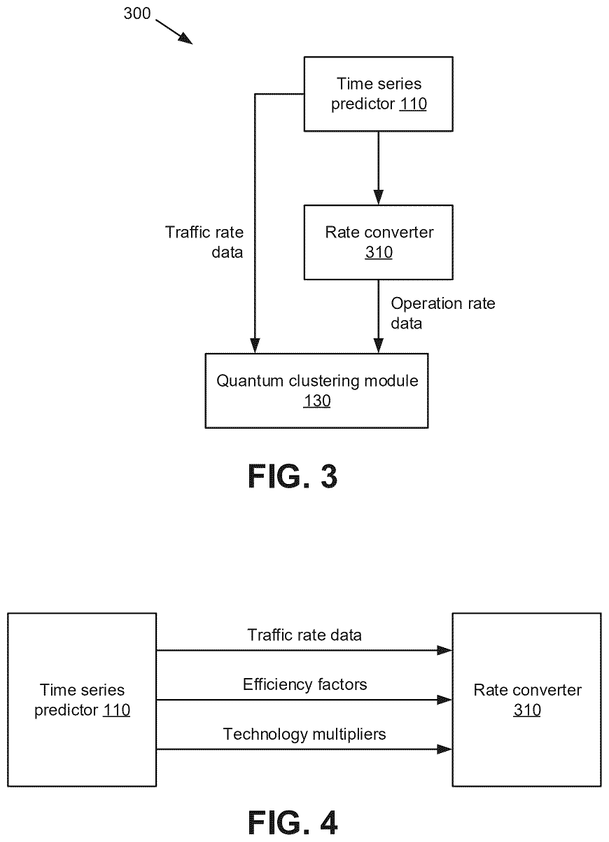

In the context of generating graph communities and performing real-time compute capacity estimation, system 100 can utilize quantum simulation methods and quantum clustering techniques as described herein to optimize resource allocation within identified traffic communities. This can include the conversion of data rate, e.g., as expressed as gigabytes per second (GBPS) into giga-operations per second (GOPS) for precise determination of server requirements, e.g., as described below with respect to FIGS. 3-5. To these and/or other ends, system 100 can facilitate one or more of the following functions:

Quantum simulation for compute capacity estimation: In implementations, system 100 can facilitate the use of quantum simulation methods, such as the Variational Quantum Eigensolver (VQE) and Quantum Monte Carlo (QMC), to estimate real-time compute capacity needs for CU and DU functions within each traffic community. These quantum algorithms can leverage qubits generated through quantum gates to encode the complex interactions and requirements of the network traffic. By simulating quantum states and optimizing their parameters, system 100 can ensure dynamic and efficient allocation of compute resources, thereby enhancing network performance and adaptability.

Quantum clustering for community pairing: In conjunction with quantum simulation, the quantum clustering module 120 can incorporate quantum clustering methods, including Quantum K-Means Clustering and Quantum Archetypal Clustering, to facilitate the identification of distinct traffic communities. Quantum clustering operates by encoding data points into quantum states represented by qubits. These qubits can then be manipulated using quantum gates to perform clustering operations based on quantum distance metrics. The resulting community pairing can reflect the intricate relationships between different traffic patterns, leading to more precise resource allocation strategies.

Qubit generation, GBPS to GOPS conversion, and server requirements: The generation of qubits can serve as the foundation for both quantum simulation and clustering within the framework utilized by system 100. These qubits can encode not only traffic patterns, but also information related to the conversion of GBPS into GOPS. Through quantum simulation and clustering and based on the conversion from GBPS to GOPS, system 100 can dynamically determine the compute capacity needs for each traffic community. By accurately assessing the compute demands of different functions within each community, the resource allocator 130 can derive the number of servers for optimal resource allocation, thereby facilitating efficient and adaptive network performance in the RAN.

Turning now to FIG. 2, an operational framework facilitating quantum-based geospatial time series archetypal clustering for radio resource allocation is illustrated. The operational framework shown in FIG. 2 can be performed by the time series predictor 110 and/or other components, such as a rate converter 310 as will be described below with respect to FIGS. 3-4, to provide near-real-time measures of the data rate of a given radio cell 20, and its corresponding data operation rate, to facilitate clustering via the quantum clustering module 120 shown in FIG. 1. In implementations, the framework shown by FIG. 2 can be of particular utility in the presence of unexpected sparse traffic burstiness and/or other such use cases.

As shown in FIG. 2, respective steps for performing data operation rate estimation using time series data (e.g., time series data collected from radio cells 20) includes a time series data rate prediction step 210 and a data rate to operation rate conversion step 220. In an implementation, the time series data rate prediction step 210 can facilitate quantum time series prediction for GBPS at a given radio. As further shown in FIG. 2, the time series data rate prediction step 210 can include data preparation 212, during which historical GBPS data from various radios can be encoded into quantum states; quantum model training 214, during which quantum circuits can be used to train a model on the time series data, leveraging algorithms such as Quantum Fourier Transform (QFT) for identifying patterns and predicting future GBPS values; and data rate encoding 216, during which the predicted GBPS data can be encoded into qubits.

By way of non-limiting example, respective actions that can be performed to facilitate the data preparation 212 shown in FIG. 2 can include the following. It is noted, however, that other techniques could also be used. The data preparation step 212 can begin by defining respective variables to be used during the data rate prediction process. These variables can be indicative of, e.g., (1) traffic volume, which could be quantified in terms of data rate (e.g., MBPS, GBPS, etc.), (2) number of UEs, e.g., the count of devices connected to each radio, and (3) mobility patterns, which could be simplified into categories (e.g., stationary, pedestrian, vehicular, etc.).

Next, the variables defined above can be converted into a discrete set of states that can be encoded into qubits. For example, traffic volume can be converted into Low, Medium, and High states, number of UEs can be converted into Few, Moderate, and Many states, and mobility patterns can be converted into Stationary, Pedestrian, and Vehicular states. Other states could also be used. In an implementation, quantum vectorization techniques, and/or other suitable techniques, can be used to transform the time-series data associated with a set of radio cells 20 into quantum states, which can enable more efficient and accurate processing and analysis of large-scale data sets for prediction and clustering purposes.

After converting the variables into discrete states, binary encoding can then be used to represent these states as qubits. In one example, two qubits can be used for each of traffic volume (e.g., 00 for Low, 01 for Medium, 10 for High, etc.), number of UEs (e.g., 00 for Few, 01 for Moderate, 10 for Many, etc.), and mobility patterns (e.g., 00 for Stationary, 01 for Pedestrian, 10 for Vehicular, etc.). Using these definitions and encodings, each radio can be represented by a total of six qubits. Thus, for example, data rate prediction for a group of 1000 radios could be performed using 6000 qubits, i.e., six qubits for each radio. To facilitate encoding the states as qubits, a quantum x gate can be applied to respective qubits to switch the qubit from the state |0 [symbol] |0 [symbol] to |1 [symbol] |1 [symbol] , representing different states of the variables.

With reference next to FIG. 3, another system 300 that facilitates quantum-based geospatial time series archetypal clustering for radio resource allocation is illustrated. Repetitive description of like parts described above with regard to other implementations is omitted for brevity. System 300 as shown in FIG. 3 includes a time series predictor 110 that can estimate data rate information (e.g., estimated GBPS) associated with predicted traffic flows of radio cells 20 (not shown in FIG. 3), e.g., as described above with respect to FIGS. 1-2. System 300 further includes a rate converter 310, which can apply quantum algorithms and/or other suitable techniques to convert the data rate information to operation rate information, e.g., as expressed in terms of GOPS. In implementations, the rate converter 310 can convert GBPS to GOPS by considering factors such as the computational complexity for encoding, modulation, and/or other baseband processing tasks.

In an implementation, the rate converter 310 can utilize a classical function to calculate GOPS for a given data rate, which can be based on information provided to the rate converter 310 by the time series predictor 110 as shown by FIG. 4. As FIG. 4 illustrates, the rate converter 310 can determine an operation rate for a given traffic data rate based on a first coefficient representative of the efficiency of network data transmission by the corresponding radio cells 20, referred to in FIG. 4 as efficiency factors, and a second coefficient representative of the efficiency of a data transmission technology utilized by the corresponding radio cells 20, referred to in FIG. 4 as technology multipliers. In an implementation, one or more of these coefficients can be determined by the time series predictor 110 based on a result of applying a quantum circuit (e.g., quantum circuit 10 as shown in FIG. 1) to time series data provided by the associated radio cells 20.

Based on the information shown in FIG. 4, the rate converter 310 can calculate the GOPS for a given traffic data flow according to the formula GOPS=Data rate×Efficiency factors×Technology multipliers. The respective components of this formula can be defined as follows.

Efficiency factors: These factors can account for the efficiency of the network's use of bandwidth and technology in transmitting data. They can include coding efficiency, modulation efficiency, and the overhead introduced by protocol layers. For example, in a network uses a modulation scheme that encodes two bits per symbol (like quadrature phase shift keying (QPSK)), and another network uses a scheme that includes six bits per symbol (like 64-QAM (quadrature amplitude modulation)), the efficiency factor could reflect these differences. Mathematically, if E_{c} is denoted as the coding efficiency and Eₘ is denoted as the modulation efficiency, an efficiency factor could be represented as E_{f}=E_{c}×Eₘ, where higher values of E_{f} indicate more efficient data transmission capabilities.

Technology multipliers: These multipliers can reflect enhancements or capabilities added by specific technologies, such as MIMO (multiple-input multiple-output) or carrier aggregation, that allow the network to handle more data simultaneously. For MIMO, the technology multiplier could be based on the number of parallel streams of data that can be transmitted and/or received, which can in some cases be equal to the minimum of the number of transmit and receive antennas. For example, a 4×4 MIMO configuration could have a technology multiplier of 4. Mathematically, if M_{MIMO} represents the MIMO multiplier and M_{CA} represents the carrier aggregation multiplier, the overall technology multiplier could be represented as Tₘ=M_{MIMO}×M_{CA}, where higher values of Tₘ indicate greater capacity to support higher data rates due to technological advancements.

By utilizing the above definitions, the rate converter 310 can then calculate the GOPS as follows:

$$GOPS = GBPS \times {E}_{f} \times {T}_{m} .$$

In an implementation, the rate converter 310 can determine the GOPS associated with a given data rate based on the data rate itself as well as additional factors, such as those associated with the modulation, coding, and/or transmission of the data at the given data rate. By way of a specific, non-limiting example in which data is transmitted from a given radio cell 20 with a Fast Fourier Transform (FFT) size of 2048 and a subcarrier spacing that results in a symbol rate of 15 kHz, various factors that can be used by the rate converter 610 to compute the associated GOPS can include, but are not limited to, the following:

Operations per FFT: In the above example, the operations per FFT would include (2048 log₂(2048))² complex multiplications, plus approximately the same number of complex additions.

Symbol rate: This parameter can depend on the specific frame structure and subcarrier spacing used. In the example of a 15 kHz subcarrier spacing, this can be the inverse of the Orthogonal Frequency Division Multiplexing (OFDM) symbol duration, which includes the cyclic prefix.

Throughput per symbol: This parameter can depend on the modulation scheme (e.g., 64-QAM, 256-QAM, etc.) and the code rate.

Based on the above, a simplified approximation of the GOPS for a radio cell 20 with an FFT size of 2048 and a symbol rate of 15 kHz (e.g., a typical rate for one OFDM symbol including a cyclic prefix in 5G), the computational load for the associated FFT operations is approximately 2.7 GOPS. In implementations, bootstrapping methods can be used to establish relationships between the network traffic, mobility, and/or other parameters of variance that can affect the data rate to GOPS conversion.

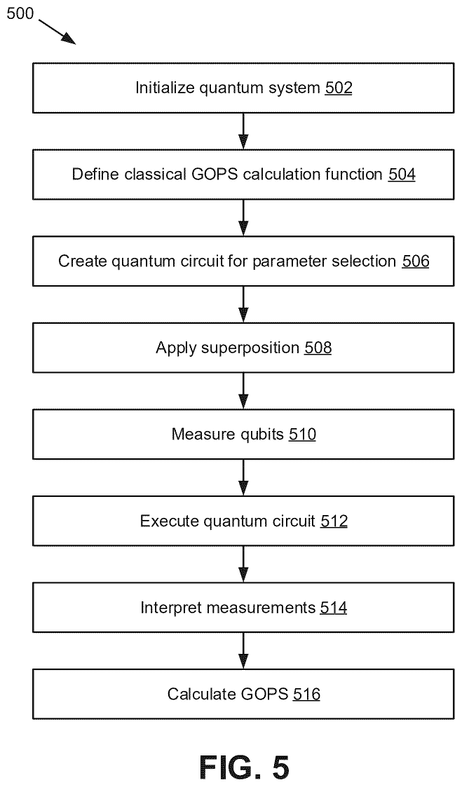

Turning next to FIG. 5, an example, non-limiting process 500 that can be utilized by the rate converter 310 to convert a given data rate (e.g., in GBPS) to GOPS using quantum processing is illustrated. The process 500 begins at 502 by initializing a quantum system, e.g., by ensuring that a quantum development environment, such as the Qiskit quantum software development kit developed by the IBM Corporation, is installed and operational. Next, at 504, a classical GOPS calculation function, such as the function described above with respect to FIG. 4, can be defined.

At 506, a quantum circuit for parameter selection can be created, e.g., by initializing a quantum circuit with two qubits and two classical bits using the Qiskit operation qc=QuantumCircuit(2, 2) or a similar operation.

At 508, superposition can be applied to the quantum circuit created at 506, e.g., by applying Hadamard gates to both qubits to put them into superposition using the Qiskit operation qc.h([0, 1]) or a similar operation.

At 510, measurement operations can be added to the circuit to collapse the qubits into classical bits, e.g., by using the Qiskit operation qc.measure([0, 1], [0, 1]) or a similar operation.

At 512, the circuit can be executed on a quantum simulator, e.g., using the Qiskit operation result=execute(qc, Aer.get_backend(‘qasm_simulator’), shots=1).result( ) or a similar operation.

At 514, the measurement results from executing the quantum circuit at 512 can be decoded and interpreted, e.g., to select efficiency factors and technology multipliers.

At 516, the classical function defined at 504 can be used with the parameters selected at 514 to calculate the GOPS.

With reference next to FIG. 6, an architectural representation of an algorithm that can be run by an Open RAN (O-RAN) RAN Intelligent Controller (RIC) for providing the instructions for pooling server resources in the CU and DU, e.g., based on radio clustering as described above, is illustrated. The user shown in FIG. 6 can represent a network operator or other administrator, and the arrows indicate data flows between the RAN and RIC components. As shown in FIG. 6, the NR-RIC is a non-real-time RIC, and the NRT-RIC is a near-real-time RIC, e.g., a RIC that can perform actions at regular intervals (e.g., 15-minute intervals, and/or other suitable intervals). It is also noted that the process shown in FIG. 6 can be performed for a cloud-based RAN, e.g., a RAN that utilizes virtualized network components running on poolable servers.

The process shown in FIG. 6 is initiated by a request for data provided by the user to the NR-RIC, which initiates capturing time series data. This time series data is analyzed by the traffic demand time series block, which is an algorithmic layer that estimates traffic demand using the time series data. This estimated demand is then provided to a machine learning (ML) module, which trains and updates an ML model based on the estimated demand. The model updates are then provided to the NRT-RIC, which updates the NR-RIC accordingly.

Next, the NR-RIC initiates analysis of associated traffic diversity by a traffic diversity dispersion algorithmic block. The evaluated diversity can then be provided to the ML module, which can train and update a diversity model that can be provided to the NRT-RIC and the NR-RIC as shown in FIG. 6.

Based on the models provided to the NR-RIC, the NR-RIC can then identify patterns in the traffic data, determine appropriate pools of CUs and/or DUs, and optimize the resource allocation to the CUs and DUs. The NR-RIC can then facilitate server pooling for the CUs and DUs, e.g., by facilitating pooling of CU/DU resources in the cloud for identified communities of the CUs and/or DUs. While FIG. 6 shows an example in which both CU and DU servers are pooled, it is noted that pooling could also be performed for only CUs, or only DUs, depending on implementation.

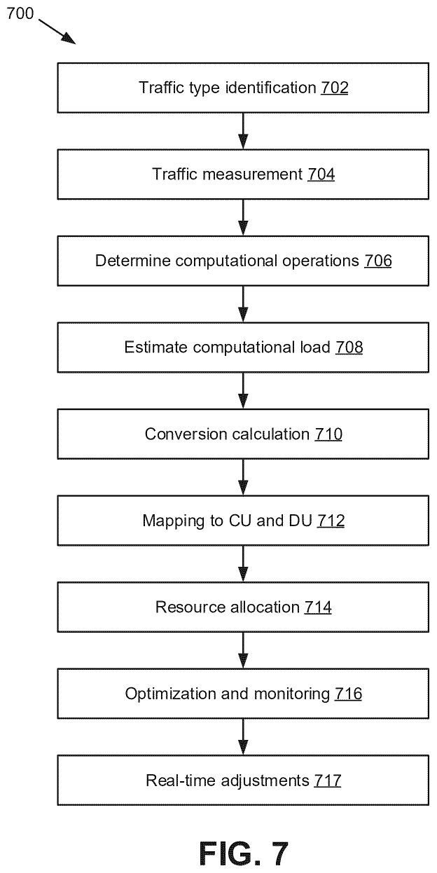

As shown in FIG. 6, the illustrated server pooling process can result in statistical multiplexing gains, e.g., associated with a reduction in computing resources associated with allocating resources to communities of radios instead of uniform groups of radios that are not clustered according to communities. Additionally, the analysis steps shown in FIG. 7 can be repeated at regular intervals, e.g., intervals at which the NRT-RIC operates, to ensure that statistical multiplexing gains continue to be realized over time.

Turning next to FIG. 7, a flow diagram of an example process 700 that can be performed by server pooling logic, e.g., logic associated with the NR-RIC and/or NRT-RIC shown in FIG. 6, is illustrated. The process 700 shown by FIG. 7 can begin with traffic type identification 702 and traffic measurement 704 for a given traffic flow, which can include remote sensing based on data captured on the network. Next, at 706, the computational operations associated with the identified and measured traffic can be determined, based on which a computational load can be estimated at 708.

At 710, the computational load estimated at 708 can be converted into an amount of data operations, and the converted amount of data operations can be mapped to a number of CUs and/or DUs at 712. Resource allocation can then be performed at 714 based on the number of CUs and/or DUs, and this resource allocation can be optimized and/or monitored at 716. Additionally, real-time adjustments can be made to the resource allocation at 718.

In an implementation, the amount of compute resources, e.g., as expressed as a number of computation servers, to be allocated for respective remote radio heads (RRHs) can be implemented via a function that takes two input parameters. First, a user_loads parameter can be used, which can be a list of lists where each inner list represents the loads of a given RRH. Each list can include a task load value and a communication load value, and collectively this parameter can represent the resource demands of each RRH. Second, a maximum_capacity parameter can be used that can represent the maximum capacity of each computation server, e.g., as expressed as the maximum GOPS a server can perform and/or in another suitable manner. This parameter can signify the maximum amount of workload that a single server can handle.

Based on the above input parameters, the above-noted resource estimation function can perform the following steps:

Calculating RRH and task counts: The function can begin by determining the number of RRHs and tasks based on the length of the user_loads list. This can provide the dimensions for subsequent calculations.

Calculating resource requirements per task: The function can then calculate the resource requirements for each task of each RRH. To do this, it can normalize the task loads based on the total load of each RRH. These normalized values can be stored in a task_values list, which represents the resource requirements for each task.

Calculating total resource requirements per RRH: Next, the function can calculate the total resource requirements for each RRH by summing the task_values list along its first axis. This step can result in a list of total resource requirements for each RRH.

Task allocation matrix initialization: The function can then initialize a task allocation matrix xi with all ones. This matrix can be used to allocate tasks to servers.

Calculating total resource use: The function can then calculate the total resource used by each server for each RRH. It can do this by multiplying matrix xi with the resource requirements and summing along the first axis. This step can result in a matrix rho_server, which represents the total resources used by each server for each RRH.

Determining number of computation servers: Finally, the function can determine the total number of computation servers to allocate. It can achieve this by finding the maximum value in the rho_server matrix, e.g., the highest resource usage among all servers, and then dividing this maximum value by the maximum_capacity parameter. The result can be rounded up to ensure that enough servers are provisioned to handle the loads effectively.

As a result of the above steps, the function can return the computed number of computation servers that are determined to meet the specified user loads and maximum capacity.

By utilizing server allocation procedures such as those described above with respect to FIGS. 6-7, various advantages can be achieved. These advantages can include, but are not limited to, the following:

Resource optimization: By using the data-driven approach shown in FIGS. 6-7, servers can be allocated as per actual requirements, which can save significant resources as compared to a system in which no analysis is performed and a worst case number of servers are allocated at all times.

Peak hour preparedness: The approach shown in FIGS. 6-7 can enable the provisioning of full servers during peak hours, ensuring that quality of service is maintained without overprovisioning.

Cluster-based contingency: Having different clusters with known estimated traffic can enable diversion of traffic in the event of a failure. This can ensure that quality of service is not significantly reduced and provide a robust mechanism to maintain user experience.

With reference now to FIG. 8, a flow diagram of an additional process 800 for data-driven server allocation for radio cells 20 is illustrated. FIG. 8 is shown in a staggered format, in which the blocks on the left-hand side represent data inputs and outputs while the blocks on the right-hand side represent data operations. In general, the process 800 shown in FIG. 8 can be used to address the challenges of energy efficiency in baseband processing, e.g., for 5G technologies, via the use of actions that can include, but are not limited to, the following:
1) Computing an amount of server resources to allocate based on the number of cores, which can be estimated by calculating the GOPS as derived from the GBPS at the radio level. The parameters affecting the GBPS can include traffic and mobility attributes at the radio.
2) Identifying the optimal set of radio pools and organizing them into distinct clusters, e.g., through the use of graph community pairing. This can be achieved by quantum archetypal clustering as described above, and/or via other techniques such as employing label propagation and Louvain modularity models, e.g., based on the estimated GOPS requirements from step 1 above.
3) For near real-time computation of GOPS estimations, time series forecasting can be employed for various combinations and permutations of the radio pools. In some implementations, a quantum ML algorithm can be utilized as a service within the RIC to calculate the server resources efficiently.

As shown in process 800, data inputs as shown at 802, including a list of radios to be considered as well as data relating to their radio traffic, UE mobility indices, radio traffic diversity, radio spatial distribution, and/or other properties, can be provided to a first ML model at 804, resulting in a time series prediction of radio traffic, mobility indices, traffic diversity, and/or other properties, e.g., in accordance with various aspects as described above. The output of the first ML model, as shown at 806, can include a list of radios with their respective estimated traffic attributes, as well as the time period for the predicted traffic.

In an implementation, the operations shown at 804 can be performed via quantum time series prediction for GBPS at a given radio. This can include, e.g., a data preparation step in which historical GBPS data from various radios is encoded into quantum states, e.g., as described above with respect to FIG. 2, and a quantum model training step in which quantum circuits are used to train a model on the time series data, leveraging algorithms like QFT for identifying patterns and predicting future GBPS values.

Next, at 808, the BBU server resources needed for the estimated and/or forecasted RU traffic, RU traffic diversity, and/or mobility can be computed by calculating the total GOPS to be provisioned to the radios based on the GBPS. In an implementation, GOPS conversion can be performed as described above with respect to FIGS. 3-5, e.g., by encoding the predicted GBPS data into qubits and then applying quantum algorithms to convert the GBPS into GOPS, considering the computational parameters for encoding, modulation, and other baseband processing tasks.

In an implementation, the outcome of the above steps can include a list of the associated radios along with their calculated amounts of BBU server resources (e.g., cores) needed to support their estimated radio traffic, e.g., as shown at 810.

Next, at 812, quantum clustering for community pairing, and/or other techniques, can be used to compute clusters or communities of radio pools with similar needs of BBU server resources. For example, quantum clustering can be performed at 812 using a data encoding step, in which GOPS data and/or other relevant traffic characteristics are encoded into quantum states, and a quantum clustering step, in which quantum K-means clustering, quantum archetypal clustering, and/or other techniques are used to group radios into communities with similar traffic patterns, leveraging quantum distance metrics for precise clustering.

The outcome of the community pairing at 812 can include a list of radios with their identities in distinct pools or clusters of communities that share common BBU resource needs, e.g., as shown at 814. In an aspect, the operations shown at 804, 808, and 812 can be implemented in a cascade ML pipeline.

Based on the list shown at 814, appropriate numbers of servers can be instantiated on the cloud at 816 for the respective pools of radios. In order to instantiate the proper number of servers for a given radio, quantum BBU server pool estimation can also be performed at 816. This server pool estimation can include a quantum resource estimation step, in which the output from the quantum clustering at 812 can be used to estimate the computation and storage needs for each traffic community in GOPS, and a server pool allocation step, in which the optimal allocation of BBU server resources can be determined, e.g., using quantum optimization algorithms to dynamically match server capacity with estimated compute needs to ensure efficient and adaptive resource distribution.

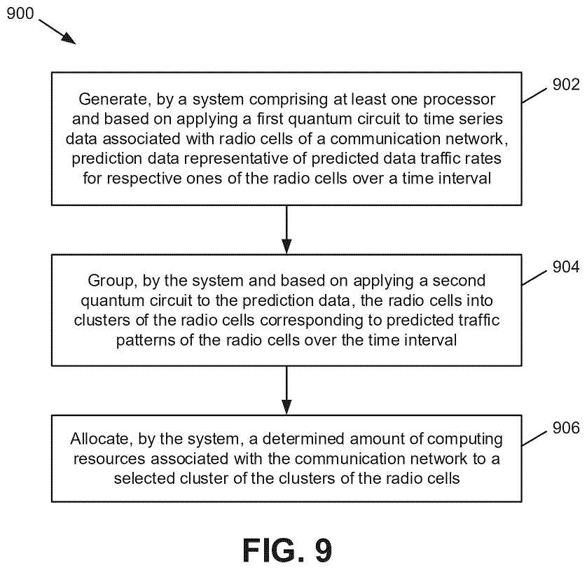

Turning to FIG. 9, a flow diagram of a method 900 that facilitates quantum-based geospatial time series archetypal clustering for radio resource allocation is illustrated. At 902, a system comprising at least one processor can generate (e.g., by a time series estimator 110), based on applying a first quantum circuit (e.g., a quantum circuit 10) to time series data associated with radio cells (e.g., radio cells 20) of a communication network, prediction data representative of predicted data traffic rates for respective ones of the radio cells over a time interval.

At 904, the system can group (e.g., by a quantum clustering module 120), based on applying a second quantum circuit (e.g., a quantum circuit 12) to the prediction data generated at 902, the radio cells into clusters of the radio cells corresponding to predicted traffic patterns of the radio cells over the time interval.

At 906, the system can allocate (e.g., by a resource allocator 130) a determined amount of computing resources associated with the communication network (e.g., servers or portions of servers, such as processors or processor cores) to a selected cluster of the clusters of the radio cells created at 904.

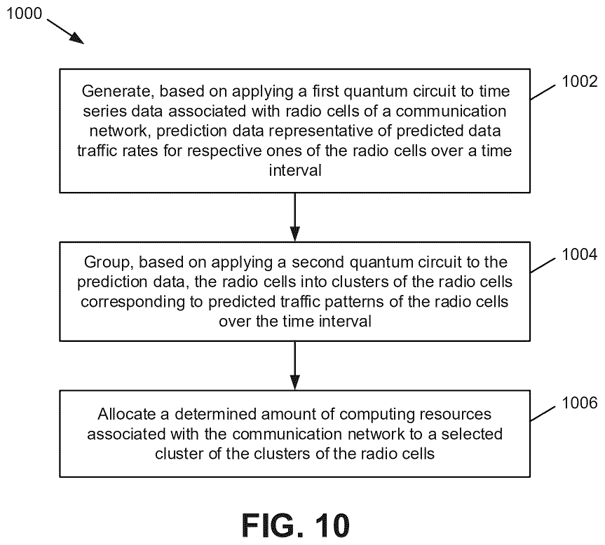

Referring next to FIG. 10, a flow diagram of a method 1000 that can be performed by at least one processor, e.g., based on machine-executable instructions stored on a non-transitory machine-readable medium, is illustrated. An example of a computer architecture, including a processor and non-transitory media, that can be utilized to implement method 1000 is described below with respect to FIG. 11.

Method 1000 can begin at 1002, in which the at least one processor can generate, based on applying a first quantum circuit to time series data associated with radio cells of a communication network, prediction data representative of predicted data traffic rates for respective ones of the radio cells over a time interval.

At 1004, the at least one processor can group, based on applying a second quantum circuit to the prediction data, the radio cells into clusters of the radio cells corresponding to predicted traffic patterns of the radio cells over the time interval.

At 1006, the at least one processor can allocate a determined amount of computing resources associated with the communication network to a selected cluster of the clusters of the radio cells.

FIGS. 9-10 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 11 and the following discussion are intended to provide a brief, general description of a suitable computing environment 1100 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 11, an example general-purpose environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD), a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 12 is a schematic block diagram of another computing environment 1200 with which various implementations described herein can interact. As shown in FIG. 12, the environment 1200 can include a local (classical) computing system 1210, which can implement one or more general-purpose or special-purpose computing devices, such as that described above with respect to FIG. 11. In implementations, classical computing functionality of one or more executable components as described herein, such as the components 110, 120, 130 of system 100 and/or other components as described herein, can be implemented via respective components of the local computing system 1210. As further shown, the local computing system 1210 can interact with one or more local data stores 1212 to store data associated with the operation of the local computing system 1210. While the local computing system 1210 and local data store(s) 1212 are illustrated in FIG. 12 as being collocated, it is noted that local data stores 1212 could be maintained via separate facilities or devices, such as a network attached storage (NAS) system, that is physically separate from the local computing system 1210.

As further shown in FIG. 12, the environment 1200 can include a remote (quantum) computing system 1220, which can employ quantum computing hardware and/or a mixture of quantum and classical computing hardware to perform quantum computing functions. In some implementations, the remote computing system 1220 could also be a fully classical computing system that is operable to simulate quantum circuits and/or quantum computing functions. The remote computing system 1220 shown in FIG. 12 can also interact with one or more remote data stores 1222, which can store data associated with the operation of the remote computing system 1220. The remote data stores 1222 could be of a similar type as the local data stores 1212 described above and/or of a different type, depending on implementation.

As additionally shown by FIG. 12, the local computing system 1210 and the remote computing system 1220 can communicate with each other via the use of a communication framework 1230. The communication framework 1230 shown in FIG. 12 can include means for communicatively coupling the local computing system 1210 to the remote computing system 1220, such as one or more computing networks and/or internetworks that can communicate with each other via one or more wired or wireless networking protocols as generally known in the art. In addition, the communication framework 1230 shown in FIG. 12 can include application programming interfaces (APIs) and/or other mechanisms by which the local computing system 1210 can direct the operation of the remote computing system 1220. For example, the remote computing system 1220 can be a cloud computing system that implements a quantum computing service, and the local computing system 1210 can utilize APIs defined by the communication framework 1230 to provide a quantum instruction file to the remote computing system 1220, e.g., via a YANG (Yet Another Next Generation) file and/or other suitable format. Other implementations for using the communication framework 1230 could also be used.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
generating, using a first quantum circuit and based on time series data associated with radio cells of a communication network, prediction data comprising predicted data traffic rates for respective ones of the radio cells over a time interval;
grouping, using a second quantum circuit, the radio cells into clusters of the radio cells according to predicted traffic patterns of the radio cells over the time interval as determined based on the prediction data; and
assigning a determined amount of computing resources associated with the communication network to a selected cluster of the clusters of the radio cells.

2. The system of claim 1, wherein the operations further comprise:
converting the predicted data traffic rates for the respective ones of the radio cells to predicted rates of computing operations for the respective ones of the radio cells, and wherein the prediction data further comprises the predicted rates of computing operations.

3. The system of claim 2, wherein the converting is based on a function of the predicted data traffic rates for the respective ones of the radio cells, a first coefficient representative of first efficiency of network data transmission by the respective ones of the radio cells, and a second coefficient representative of second efficiency of a data transmission technology utilized by the respective ones of the radio cells.

4. The system of claim 3, wherein the first coefficient relates to a modulation and coding scheme utilized by the respective ones of the radio cells.

5. The system of claim 3, wherein the data transmission technology associated with the second coefficient is selected from a group of technologies comprising multiple-input-multiple-output communication and carrier aggregation.

6. The system of claim 1, wherein the operations further comprise:
determining, as the determined amount of computing resources, a number of server devices to allocate to the selected cluster.

7. The system of claim 6, wherein the determining of the number of the server devices is based on a function of communication task loads being served via respective radio cells, of the radio cells and that are associated with the selected cluster, and a computational capacity of the server devices.

8. The system of claim 1, wherein the operations further comprise:
monitoring service quality metrics associated with the clusters of the radio cells; and
adjusting the determined amount of the computing resources based on a result of comparing the service quality metrics to a service quality threshold defined by a service level agreement.

9. The system of claim 8, wherein the adjusting comprises adjusting a number of computational cores allocated to the selected cluster of the radio cells based on real-time traffic fluctuations associated with the selected cluster.

10. The system of claim 1, wherein the first quantum circuit and the second quantum circuit are associated with a cloud-based quantum computing system.

11. The system of claim 1, wherein the operations further comprise:
transforming the time series data into a group of quantum states using quantum vectorization, wherein the generating of the prediction data comprises applying the first quantum circuit to the group of quantum states.

12. A method, comprising:
generating, by a system comprising at least one processor and based on applying a first quantum circuit to time series data associated with radio cells of a communication network, prediction data representative of predicted data traffic rates for respective ones of the radio cells over a time interval;
grouping, by the system and based on applying a second quantum circuit to the prediction data, the radio cells into clusters of the radio cells corresponding to predicted traffic patterns of the radio cells over the time interval; and
allocating, by the system, a determined amount of computing resources associated with the communication network to a selected cluster of the clusters of the radio cells.

13. The method of claim 12, further comprising:
converting, by the system, the predicted data traffic rates for the respective ones of the radio cells to predicted rates of computing operations for the respective ones of the radio cells, wherein the grouping comprises grouping the radio cells based on the predicted rates of computing operations.

14. The method of claim 13, wherein the converting is based on a function of the predicted data traffic rates for the respective ones of the radio cells, a first coefficient representative of first efficiency of network data transmission by the respective ones of the radio cells, and a second coefficient representative of second efficiency of a data transmission technology utilized by the respective ones of the radio cells.

15. The method of claim 14, wherein:
the first coefficient relates to a modulation and coding scheme utilized by the respective ones of the radio cells, and
the data transmission technology associated with the second coefficient is selected from a group of technologies comprising multiple-input-multiple-output communication and carrier aggregation.

16. The method of claim 12, further comprising:
determining, by the system, a number of server devices to allocate to the selected cluster as the determined amount of computing resources, the determining of the number of the server devices being based on a function of communication task loads being served via respective radio cells, of the radio cells and that are associated with the selected cluster, and a computational capacity of the server devices.

17. A non-transitory machine-readable medium comprising computer executable instructions that, when executed by at least one processor, facilitate performance of operations, the operations comprising:
generating, based on applying a first quantum circuit to time series data associated with radio cells of a communication network, prediction data representative of predicted data traffic rates for respective ones of the radio cells over a time interval;
grouping, based on applying a second quantum circuit to the prediction data, the radio cells into clusters of the radio cells corresponding to predicted traffic patterns of the radio cells over the time interval; and
allocating a determined amount of computing resources associated with the communication network to a selected cluster of the clusters of the radio cells.

18. The non-transitory machine-readable medium of claim 17, wherein the operations further comprise:
converting the predicted data traffic rates for the respective ones of the radio cells to predicted rates of computing operations for the respective ones of the radio cells, wherein the grouping comprises grouping the radio cells based on the predicted rates of computing operations.

19. The non-transitory machine-readable medium of claim 18, wherein the converting is based on a function of the predicted data traffic rates for the respective ones of the radio cells, a first coefficient representative of a modulation and coding scheme utilized by the respective ones of the radio cells, and a second coefficient representative of a data transmission technology utilized by the respective ones of the radio cells, the data transmission technology being selected from a group of technologies comprising multiple-input-multiple-output communication and carrier aggregation.

20. The non-transitory machine-readable medium of claim 17, wherein the operations further comprise:
determining a number of server devices to allocate to the selected cluster as the determined amount of computing resources, the determining of the number of the server devices being based on a function of communication task loads being served via respective radio cells, of the radio cells and that are associated with the selected cluster, and a computational capacity of the server devices.
